(19) United States
(12) Patent Application Publication
(10) Pub. No.: US 2017/0076512 A1
(43) Pub. Date: Mar. 16, 2017

(54) SYSTEM AND METHOD FOR CHECKING A VALIDITY OF A SERVICE COMPONENT OF A MACHINE

(71) Applicant: Caterpillar Inc., Peoria, IL (US)

(72) Inventors: Lonny E. Johnson, Peoria, IL (US); Brad K. Borland, Peoria, IL (US); Gopi K. Gaddipati, Peoria, IL (US)

(73) Assignee: Caterpillar Inc., Peoria, IL (US)

(21) Appl. No.: 14/851,009

(22) Filed: Sep. 11, 2015

(51) Int. Cl. G07C 5/08; G07C 5/00

(52) U.S. Cl. CPC G07C 5/08; G07C 5/008

(57) ABSTRACT

A method for checking a validity of a service component of a machine is described. The method includes receiving a signal indicative of an identifier code associated with the service component. The method also includes determining the identifier code based on the signal. The method further includes checking for a log value corresponding to the identifier code. The method further includes comparing the log value and a threshold value. The method further includes generating an output signal, indicative of the validity of the service component, if the log value exceeds the threshold value.

### TECHNICAL FIELD

The present disclosure relates generally to a system and a method for checking a validity of a service component installed in a machine, and more particularly relates to a system and a method for checking a validity of a service component using log values associated with the service component.

### BACKGROUND

Generally, machines such as track-type tractors, dozers, motor graders and wheel loaders include a number of components which work in coordination to perform various operations in the machine. Some of these components may need to be replaced at some stage of machine operation. Such components have routinely been a target for counterfeiters who manufacture relatively cheap, but poorly designed duplicate components. These duplicate components generally do not meet the standards for original components, as set by Original Equipment Manufacturers (OEM's), and when used, may result in damage to the machine and related accessories.

Most OEM's include some type of identification tool, such as marks, labels, codes, etc. on the manufactured components to assist an operator of the machine to distinguish between the original component and the duplicate component. However, the counterfeiters may be able to replicate these identification tools on the duplicate components, and thus be able to deceive the operator to accept the duplicate components as the original components. However, the manufacturer of the machine may not be able to afford the risk to allow for use of the duplicate components in the machine.

US Patent Publication Number 2010/0017248 describes a system and method for tracking of business information and more specifically to the tracking of physical objects within a production environment. The reference provides tags which may be employed to authenticate the genuineness of the physical object. However, the reference does not provide any particular means to protect against a fraud in which a counterfeiter may attempt to remove the tag of the original component, replicate the tag to produce a number of copies, and use such copies of the tag with each of the duplicate component. Therefore, there is a need of a system and a method for checking a validity of a component against such possible fraudulent attempts by counterfeiters.

### SUMMARY OF THE DISCLOSURE

In one embodiment of the present disclosure, a method for checking a validity of a service component of a machine is described. The method includes receiving a signal indicative of an identifier code associated with the service component. The method also includes determining the identifier code based on the signal. The method further includes checking for a log value corresponding to the identifier code. The method further includes comparing the log value and a threshold value. The method further includes generating an output signal, indicative of the validity of the service component, if the log value exceeds the threshold value.

In another embodiment of the present disclosure, a control system for checking the validity of the service component of the machine is described. The control system includes a perception unit configured to receive the signal indicative of the identifier code associated with the service component. The perception unit is further configured to determine the identifier code based on the signal. The control system also includes a controller. The controller is configured to check for the log value corresponding to the identifier code. The controller is also configured to compare the log value and the threshold value. The controller is further configured to generate the output signal, indicative of the validity of the service component, if the log value exceeds the threshold value.

In yet another embodiment of the present disclosure, a machine is described. The machine includes a frame and where the service component is installed in the frame. The machine includes the control system for checking the validity of the service component. The control system includes the perception unit configured to receive the signal indicative of the identifier code associated with the service component. The perception unit is further configured to determine the identifier code based on the signal. The control system also includes the controller. The controller is configured to check for the log value corresponding to the identifier code. The controller is also configured to compare the log value and the threshold value. The controller is further configured to generate the output signal, indicative of the validity of the service component, if the log value exceeds the threshold value.

Other features and aspects of this disclosure will be apparent from the following description and the accompanying drawings.

### BRIEF DESCRIPTION OF THE DRAWINGS

FIG. 1 is a perspective view of an exemplary machine in which a service component is installed, in accordance with an embodiment of the present disclosure;

FIG. 2 is a partially exploded perspective view of an exemplary service component, in accordance with an embodiment of the present disclosure;

FIG. 3 is a schematic block diagram of an electronic device, in accordance with an embodiment of the present disclosure;

FIG. 4 is a schematic block diagram of a control system, in accordance with an embodiment of the present disclosure; and

FIG. 5 is a flowchart of a method for checking a validity of the service component, in accordance with one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

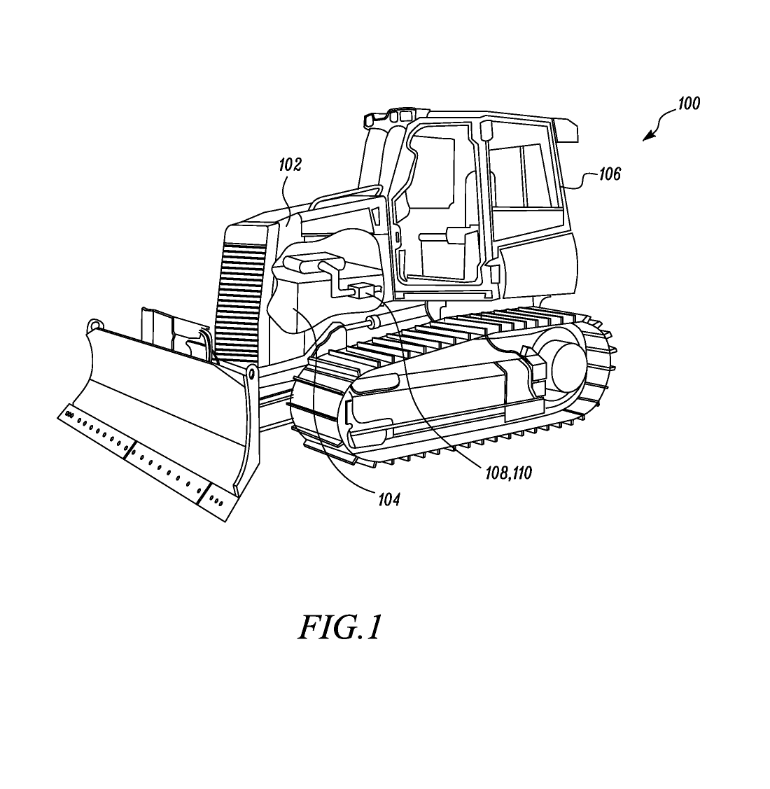

FIG. 1 illustrates a perspective view of a machine 100. The machine 100, as depicted in FIG. 1, may embody an earth moving machine, such as a dozer having traction devices, such as tracks, wheels, or the like. Alternatively, the machine 100 may be some other off-highway vehicle, such as an excavator, a backhoe, a loader, a motor grader, or any other machine. In one example, the machine 100 may be configured to perform operations at a worksite, for example, a mine site, a landfill, a quarry, a road site, a farm, a construction site, or any other similar type of worksite. The machine 100 may be any of a manual, an automated or a semi-automated machine. Alternatively and/or additionally, the machine 100 may include a stationary machine such as a generator set, a pumping device, a turbine, or some other type of stationary machine.

In the illustrated aspect of FIG. 1, the machine 100 includes a frame 102 to support the various components therein. The machine 100 may include an engine 104 configured to power the traction devices, and other systems and assemblies in the machine 100. The engine 104 may be an internal combustion engine, such as a gasoline engine, a diesel engine, a gaseous fuel burning engine, or the like. The machine 100, as illustrated, may also include an operator cabin 106 from where an operator of the machine 100 may control various systems and assemblies to perform the requisite operations.

As shown in the exemplary embodiment of FIG. 1, the machine 100 may include exhaust treatment devices 108. The exhaust treatment devices 108 may be configured to remove particulate matter, such as, soot and ash from an exhaust flow of the engine 104. The exhaust treatment devices 108 may include, for example, a filter configured to trap the particulate matter. It may be contemplated by a person skilled in the art that the usage of filter for extended periods of time may lead to accumulation of the particulate matter, thereby causing the filter to reduce in effective volume and resulting in a decline in engine performance. The exhaust treatment devices 108 may include other such devices, such as catalytic conversion devices that are used to treat or condition passing fluids and often have fluid-treatment coatings that degrade during the operations of the machine 100. In addition to the exhaust treatment devices 108, the machine 100 may include other devices that may degrade over a period of time and/or develop faults, and are required to be replaced with a new device for efficient working of the machine 100. These categories of devices are hereinafter collectively referred to as “service components” for the purpose of the present disclosure.

The machine 100 may include one or more service components 110 installed in the frame 102. In one example, the service components 110 may include a variety of filters that are used to treat various kinds of fluids in the machine 100, for example, but not limited to, engine oil filters, transmission oil filters, exhaust gas filters, coolant filters, fuel filters, etc. which degrade over a period of usage and thus needed to be replaced. In other example, the service components 110 may also include other type of components, such as, engine oil pumps, transmission oil pumps, fuel pumps, coolant pumps, etc. which form cavities after a period of usage and thus needed to be replaced. In yet other examples, the service components 110 may also include accessories and service components, such as, tires, meters and gauges, valves, supply lines, etc. which may degrade during operations of the machine 100 and thus need replacement for proper functioning thereof.

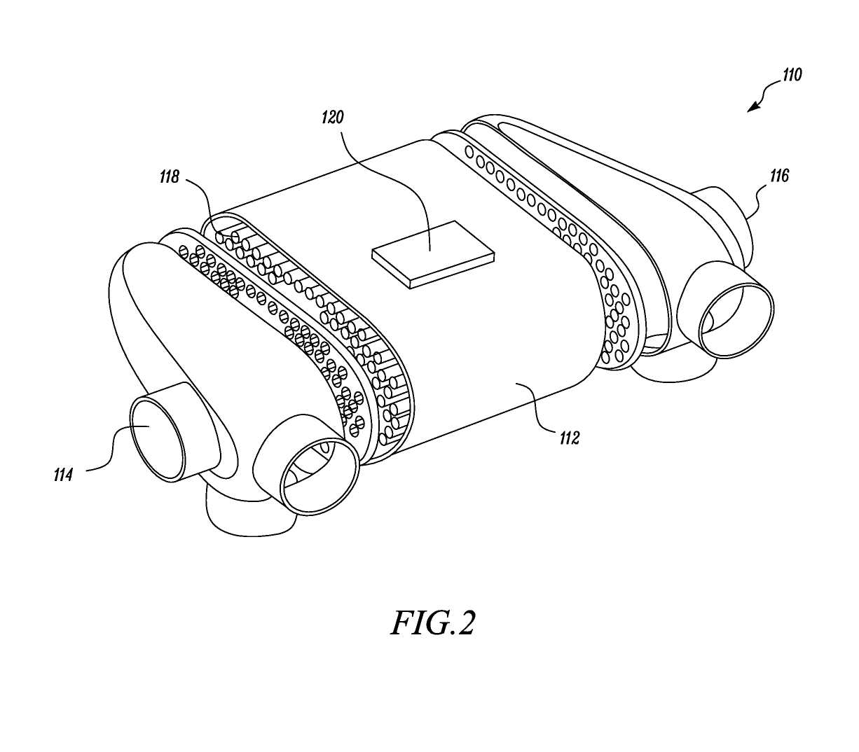

FIG. 2 illustrates an exemplary configuration of the service component 110. The service component 110 is shown as a filter which is used for treating exhaust gases in the machine 100. The service component 110, as shown in FIG. 2, may be designed to remove particulate matter or soot from the exhaust gases. The service component 110, as shown in FIG. 2, may include a body 112 in which one or more inlet ports 114 and one or more outlet ports 116 are provided. The service component 110 may further include filter elements 118 disposed within the body 112. In the service component 110 of FIG. 2, the one or more inlet ports 114 may receive the exhaust gases from a combustion chamber (not shown) of the engine 104 via the inlet ports 114, route the exhaust gases through the filter elements 118 for treatment and subsequently discharge the exhaust gases via the outlet ports 116. In this process, the filter elements 118 may be consumed and/or degraded by accumulation of the particulate matter, etc. Thereafter, the filter elements 118 may no longer be suitable for sufficiently treating the exhaust gases. At this point, it may be recommended that the operator may replace the service component 110 installed in the machine 100 with a new service component.

According to an embodiment of the present disclosure, the service component 110 may be manufactured to include an electronic device 120. The electronic device 120 may be fixed to the body 112 of the service component 110, as shown in FIG. 2. The electronic device 120 may be in the form of a tag embedded or attached to the body 112 of the service component 110. In one example, the electronic device 120 and its associated circuits may be powered by a battery (not shown) disposed in the service component 110 or directly with the electronic device 120. In another example, the electronic device 120 may be powered by an energy harvester unit (not shown), such as, but not limited to, solar cell, piezo cell, and the like. In an alternate example, the electronic device 120 may derive power from the engine 104 of the machine 100.

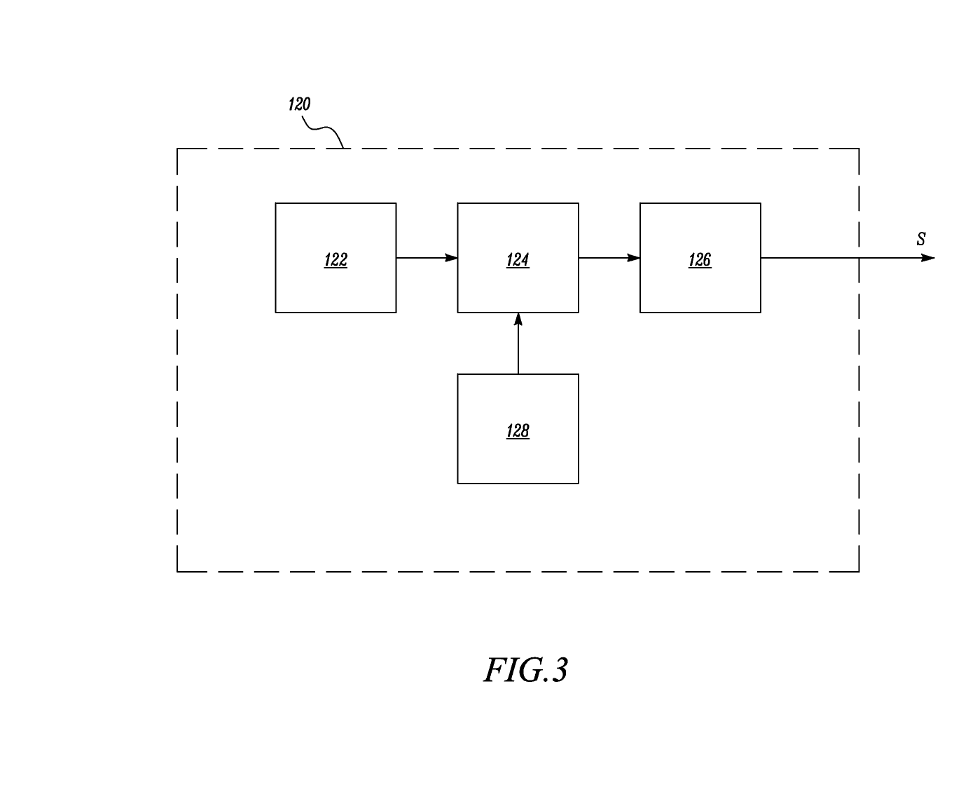

In an exemplary embodiment, as illustrated in FIG. 3, the electronic device 120 may include a memory 122, such as a read-only memory (ROM), a random access memory (RAM), a non-volatile memory, etc. The memory 122 may be configured to store an identifier code ‘X’ associated with the service component 110. It may be understood that the identifier code ‘X’ may be in the form of a data string which may be unique to the corresponding service component 110, and therefore be used to distinguish one service component from other service components of the same or different type.

The electronic device 120 may also include a microcontroller 124 in communication with the memory 122 over a data bus or the like. The microcontroller 124 may be configured to generate a signal ‘S’ indicative of the identifier code ‘X’. The microcontroller 124 may be configured to generate the signal ‘S’ according to one of the wireless communication standards known in the art. In particular, the microcontroller 124 may be configured to encode the information about the identifier code ‘X’ to generate the signal ‘S’. The signal ‘S’ may further be encrypted based on the wireless communication standard adopted for encoding the signal ‘S’.

The electronic device 120 may further include a transmitter 126. The transmitter 126 may be configured to transmit the signal ‘S’ based on the wireless communication standard adopted for encoding the signal ‘S’. In one example, the transmitter 126 may transmit the signal ‘S’ as one of a Bluetooth Low Energy (BLE) signal, a Bluetooth signal, an RFID signal, an infrared signal, a Wi-Fi signal, a NFC signal, a cellular signal, a RuBee signal, a wired signal and a hybrid signal. In an embodiment of the present disclosure, the transmitter 126 may be configured to transmit the signal ‘S’ as a Bluetooth Low Energy (BLE) signal. The microcontroller 124 may be configured to encode the information about the identifier code ‘X’ in the signal ‘S’ as per the Bluetooth Low Energy standard. Hereinafter, the terms “Bluetooth Low Energy signal” and “signal” have been interchangeably used.

The electronic device 120 may also include a timing module 128 in communication with the transmitter 126. The timing module 128 may include one or more algorithms with a set of instructions to regulate the transmitter 126 for transmitting the signal ‘S’. In one example, the timing module 128 may configure the transmitter 126 to transmit the signal ‘S’ continuously after regular intervals of time. In other example, the timing module 128 may configure the transmitter 126 to transmit the signal ‘S’ in response to the machine 100 being started, as detected by known means. It maybe contemplated by a person skilled in the art that the timing module 128 may regulate the transmission of the signal ‘S’ in order to conserve power consumed by the electronic device 120. In one example, the electronic device 120 may also include an accelerometer (not shown) which may configure the transmitter 126 to transmit the signal ‘S’ in response to a movement of the machine 100.

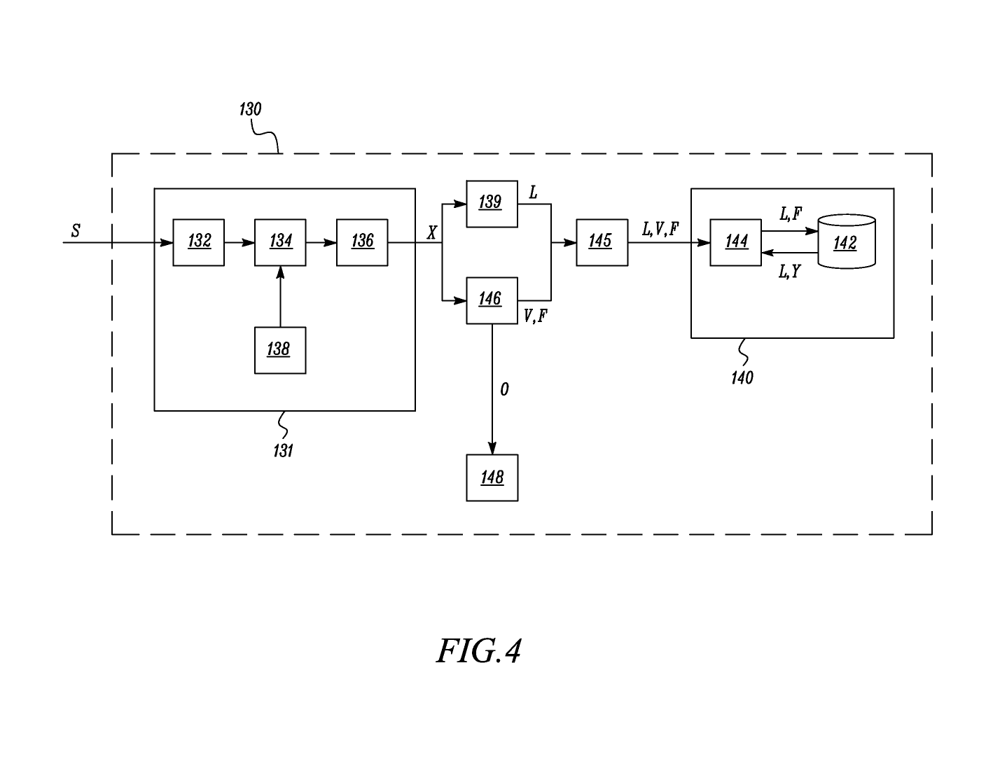

In an embodiment, the present disclosure provides a control system 130, as schematically illustrated in FIG. 4. The control system 130 may be configured to check for a validity of the service component 110. In particular, the control system 130 may be configured to check the validity of the service component 110 installed in the machine 100. The term “validity” herein refers to authentic or inauthentic nature of the service component 110, that is, whether the service component 110 has been manufactured by an Original Equipment Manufacturer (OEM) or not. Hereinafter, the service components 110 which are authentic are called “original components” and those which are inauthentic are called “duplicate components”.

The control system 130 may include a perception unit 131. The perception unit 131 may be disposed in the machine 100, for example, in the operator cabin 106. The perception unit 131 may include a transceiver 132 disposed in wireless communication with the transmitter 126 of the electronic device 120. The transceiver 132 may be configured to monitor for the signal ‘S’ transmitted from the service component 110 installed in the machine 100. The transceiver 132 may also be configured to receive the signal ‘S’ therein.

The perception unit 131 may also include a microcontroller 134. The microcontroller 134 may be configured to determine the identifier code ‘X’ from the signal ‘S’, in response to receiving the signal ‘S’. Specifically, the microcontroller 134 may be configured to decode the signal ‘S’ to determine the identifier code ‘X’. It may be contemplated that the microcontroller 134 may process the signal ‘S’ with the same wireless communication standard as used by the microcontroller 124 of the electronic device 120, in order to decode/decrypt the signal ‘S’. In an embodiment of the present disclosure, the microcontroller 134 may be configured to use the Bluetooth Low Energy standard for decoding the signal ‘S’. The perception unit 131 may also include a memory 136 in communication with the microcontroller 134, such as a random access memory (RAM) or some other non-volatile memory. The memory 136 may be configured to receive and store the identifier code ‘X’, as decoded by the microcontroller 134.

The perception unit 131 may also include a timing module 138. The timing module 138 may include one or more algorithms with a set of instructions to regulate the transceiver 132 for monitoring the signal ‘S’. In one example, the timing module 138 may configure the transceiver 132 to monitor for the signal ‘S’ after regular intervals of time. In other example, the timing module 138 may configure the transceiver 132 to monitor for the signal ‘S’ in response to starting of the machine 100, as detected by known means. In one example, the timing module 138 may configure the transceiver 132 to be in sync with the transmitter 126 by means of the timing module 128. It may be contemplated that the timing module 138 may regulate the monitoring of the signal ‘S’ in order to conserve power in the transceiver 132.

In an embodiment, the control system 130 may also include a control module 139. The control module 139 may be disposed in connection with the engine 104 of the machine 100, as has been representatively shown in FIG. 1. In one example, the functions of the control module 139 may be integrated into an Electronic Control Module (ECM), generally provided with the engines 104. The control module 139 may be disposed in communication with the perception unit 131 to receive information about the service components 110, such as the identifier code ‘X’. The control module 139 may be configured to detect the service components 110 installed in the machine 100 based on the identifier code ‘X’.

The control module 139 may further utilize a plurality of sensors (not illustrated) for determining the operating parameters of the engine 104, and thereby the machine 100. The control module 139 may be configured to monitor and record logs for operations of the machine 100. The control module 139 may be configured to generate event logs ‘E’ about the service components 110 installed in the machine 100, based on the respective identifier codes ‘X’. The event logs ‘E’ may correspond to the occurrence of the service component 110 associated with the identifier codes ‘X’. The control module 139 may also monitor the time periods in which the machine 100 has been engaged in performing operations, planned or unplanned. The control module 139 may therefore indirectly monitor the length of time for which the service component 110 has been used in the machine 100. The control module 139 may record this information as time logs ‘T’, indicative of a length of time the service component 110 has been operational in the machine 100.

The control system 130 may also include a database 140. The database 140 may include a memory unit 142 and a processing unit 144. The memory unit 142 may include one or more mass storage media, such as, but not limited to, hard drives, magnetic tapes, CD-ROMs, DVD-ROMs, and the like. The memory unit 142 may be configured to store data including a set of pre-stored identifier codes. The set of pre-stored identifier codes may include a number of pre-stored identifier codes ‘Y’. The pre-stored identifier codes ‘Y’ correspond to the identifier codes ‘X’ for each of the service components 110 manufactured with the electronic device 120 of the present disclosure. The processing unit 144 may include one or combination of processors, microprocessors, microcontrollers, and other processing means for carrying out instructions based on some algorithms. The processing unit 144 may be configured to store, organize, sort, filter, and/or arrange data in the memory unit 142.

In an embodiment, the control module 139 may be disposed in communication with the database 140. The control system 130 may include a communication device 145 to facilitate communication between the control module 139 and the database 140. The communication device 145 may utilize suitable communication means, such as, but not limited to, Wi-Fi, Wi-Max, GSM, CDMA, Broadband, satellites, hybrid network, or any other communication means known in the art. In one example, the database 140 may be disposed in a control center (not illustrated) located remotely of the machine 100, such as, in a cloud based server. In such a case, the communication device 145 may include a modem to access the database 140. Alternatively, the transceiver 132 may represent separate transmission and receiver devices, or other devices for providing the communication interface between the control module 139 and the database 140.

The control module 139 may send the information about the time log ‘T’ and/or the event log ‘E’ data to the database 140, via the communication device 145. Hereinafter, the terms time log ‘T’ and the event log ‘E’ have been denoted by the term log value ‘L’. It may be contemplated that the log value ‘L’ may represent information either about the time log ‘T’ or the event log ‘E’ depending on the requirement. In one example, the control module 139 may be configured to sync the log value ‘L’ with the database 140. In other example, the control module 139 may receive requests about the log value ‘L’ from the database 140.

In the database 140, the processing unit 144 may organize, sort, filter, and/or arrange the log value ‘L’ to be stored in the memory unit 142. In particular, the processing unit 144 may associate the log value ‘L’ for the service component 110 with the identifier code ‘X’ to the corresponding pre-stored identifier code ‘Y’ in the memory unit 142. It may be understood that indirectly the log value ‘L’ is being associated with the identifier code ‘X’. The processing unit 144 may be configured to keep updating the memory unit 142 with the log value ‘L’, as received from the control module 139. The database 140 may receive the log value ‘L’ from multiple control modules 139 of multiple machines 100. In such cases, the log value ‘L’ denoting the event log ‘E’ may correspond to collective number of times one or more service components 110 associated with the identifier code ‘X’ have been installed in one or more machines 100. Similarly, the log value ‘L’ denoting the time log ‘T’ may correspond to collective length of time one or more service components 110 associated with the identifier code ‘X’ have been operational in one or more machines 100.

The control system 130 may further include a controller 146. The controller 146 may be a logic unit using any combination of processors, microprocessors, microcontrollers, or any other suitable means to execute one or more algorithms predefined therein. In one example, the controller 146 may be disposed on-board the machine 100 and in communication with the perception unit 131 by some suitable means, to receive information about the identifier code ‘X’. The controller 146 may also be in communication with the database 140, via the communication device 145. In one example, the controller 146 may form a part of the perception unit 131 in the control system 130. Further the functions of the controller 146 may be integrated into the microcontroller 134.

The controller 146 may be configured to match the identifier code ‘X’ with the pre-stored identifier codes ‘Y’ in the set of pre-stored identifier codes, in the memory unit 142 of the database 140. Specifically, the controller 146 may send instructions to the processing unit 144 to compare the data string of the identifier code ‘X’ with data strings of the pre-stored identifier codes ‘Y’. The processing unit 144 may check for the pre-stored identifier code ‘Y’ with the data string equivalent to the data string of the identifier code ‘X’. The processing unit 144 may, then, send a confirmation to the controller 146 that a match for the identifier code ‘X’ has been found in the memory unit 142. This process of searching a database is well known in the art and has not been described in more detail for the brevity of the disclosure.

In an embodiment, when the identifier code ‘X’ matches with one of the pre-stored identifier codes ‘Y’ from the set of pre-stored identifier codes, the controller 146 may be configured to compare the log value ‘L’ associated with the matched pre-stored identifier code ‘Y’ and a threshold value ‘V’. Specifically, the controller 146 may send instructions to the processing unit 144 to compare the log value ‘L’ associated with the matched pre-stored identifier code ‘Y’ and the threshold value ‘V’, via the communication device 145. The threshold value ‘V’ may be predefined in the controller 146. Further, the threshold value ‘V’ may be adjusted based on the requirements for checking the validity of the service component 110. In an embodiment, the controller 146 may include two threshold values corresponding to the two log values ‘L’ for both the time log ‘T’ and the event log ‘E’. For simplicity, the disclosure, hereinafter, has been described in terms of one log value ‘L’ and one threshold value ‘V’, and it may be contemplated that the same may be changed based on using the time log ‘T’ or the event log ‘E’ for the purpose of checking the validity of the service component 110.

According to an embodiment of the present disclosure, the controller 146 may be configured to generate an output signal ‘O’ based on the comparison of the log value ‘L’ and the threshold value ‘V’. Specifically, the controller 146 may be configured to generate the output signal ‘O’ if the log value ‘L’ exceeds the threshold value ‘V’. It may be understood that the output signal ‘O’ may be indicative of a validation of the service component 110. Specifically, the output signal ‘O’ may represent that the service component 110 may be a duplicate component.

In one example, if the identifier code ‘X’ does not match with any of the pre-stored identifier codes ‘Y’, the controller 146 may be further configured to generate the output signal ‘O’. In other example, the controller 146 may be further configured to generate the output signal ‘O’ in response to not receiving the signal ‘S’ at the first place, that is, for the service component 110 which may be manufactured without the electronic device 120 associated therewith.

The control system 130 may also include one or more output devices 148 configured to communicate the output signal ‘O’, as generated by the controller 146. The output devices 148 may be configured to communicate the output signal ‘O’ to a concerned authority. As used herein, the “concerned authority” may include someone who is using the service component 110, for example, a “customer”, a “user”, an “operator of the machine 100”, etc. The “concerned authority” may further include someone who is checking for the validity of the service component 110, for example, a “service personnel”, an “a supplier/dealer”, an “OEM representative”, a “law enforcement officer”, etc.

The output devices 148 may employ any combination of display screens, touchscreens, light-emitting diodes (LEDs), speakers, and the like, to provide one or more of visual and/or audible indications about the useful life of the service component 110 installed in the machine 100. The output device 148 may show the output signal ‘O’ as color-coded scheme, where the ‘RED’ indicates that the service component 110 may be the duplicate component and the ‘GREEN’ indicates that the service component 110 may be the original component.

In one example, the output devices 148 may be disposed in the operator cabin 106 from where the operator may check the validity of the service components 110 installed in the machine 100, such as for the manually operated machines. In other example, the output devices 148 may be in the form of a mobile device, such as a smartphone, a tablet, a PDA, or the like which enables the operator to remotely check the validity of the service components 110 installed in the machine 100, such as for the automatically operated machines. In still other example, the output devices 148 may be disposed in a remote location from where the service personnel may check the validity of the service components 110 installed in the machine 100.

The controller 146 may be further configured to generate an invalidation flag ‘F’ for the pre-stored identifier code ‘Y’ in the database 140 corresponding to which the output signal ‘O’ is generated. The invalidation flag ‘F’ may be used by the concerned authority for future reference purposes. The controller 146 may send, via the communication device 145, the information about the invalidation flag ‘F’ to the processing unit 144, which in turn updates the pre-stored identifier code ‘Y’ in the memory unit 142 with the information. Further, the invalidation flag ‘F’ may be communicated via the output device 148.

### INDUSTRIAL APPLICABILITY

The present disclosure describes a system and method for checking a validity of a service component. The present disclosure describes the use of an electronic device, such as the electronic device 120, associated with the service component 110 for the purpose. The electronic device 120 includes the identifier code ‘X’ unique to a service component. The identifier code ‘X’ may be used to distinguish the service components and further to differentiate between an original component and a duplicate component using the control system 130 of the present disclosure. The control system 130 may further check validities of multiple service components installed in the machine and/or in a worksite that involves a large fleet of different types of machines.

As discussed, the counterfeiter may be able to remove an electronic device of an original component and replicate such electronic device to produce a number of copies to be used with duplicate components. Other case may be that an operator of the machine may try to avoid detection of a duplicate component by using the electronic device from an original component. The operator may remove the electronic device of the original component and place the same in proximal range of validation means in the machine.

In the present disclosure, the control system 130 utilizes log value ‘L’, including the event log ‘E’ and the time log ‘T’, associated with the service component 110 to check for its validity. The control system 130 compares the log value ‘L’ to the threshold value ‘V’ and generate the output signal ‘O’ if the log value ‘L’ is greater than threshold value ‘V’, indicating that the service component 110 being checked is invalid, or in other words a duplicate component.

Considering the case, when the log value ‘L’ is denoting the event log ‘E’ for the service component 110. If the counterfeiter tries to replicate the electronic device 120 to be used with the duplicate component installed in various machines 100, the number of occurrences of the identifier code ‘X’ detected by the control module 138 would increase. Correspondingly, the log value ‘L’ corresponding to the identifier code ‘X’ would incrementally increase in the database 140. In such case, the threshold value ‘V’ may be defined to correspond to the maximum number of original components associated with identifier code ‘X’. Ideally, the threshold value ‘V’ in such case may be ‘1’. Now in comparison if the log value ‘L’ exceeds the threshold value ‘V’, the output signal ‘O’ is generated indicating that the service component 110 may be the duplicate component.

Similarly considering the case, when the log value ‘L’ is denoting the time log ‘T’ for the service component 110. It is known that the service component 110 can only last for a limited time equivalent to its useful life, when used in the machine 100. The threshold value ‘V’ may be defined to correspond to that limited time for the service component 110. Therefore in comparison if the log value ‘L’ exceeds the threshold value ‘V’, the output signal ‘O’ is generated indicating that the service component 110 may be the duplicate component.

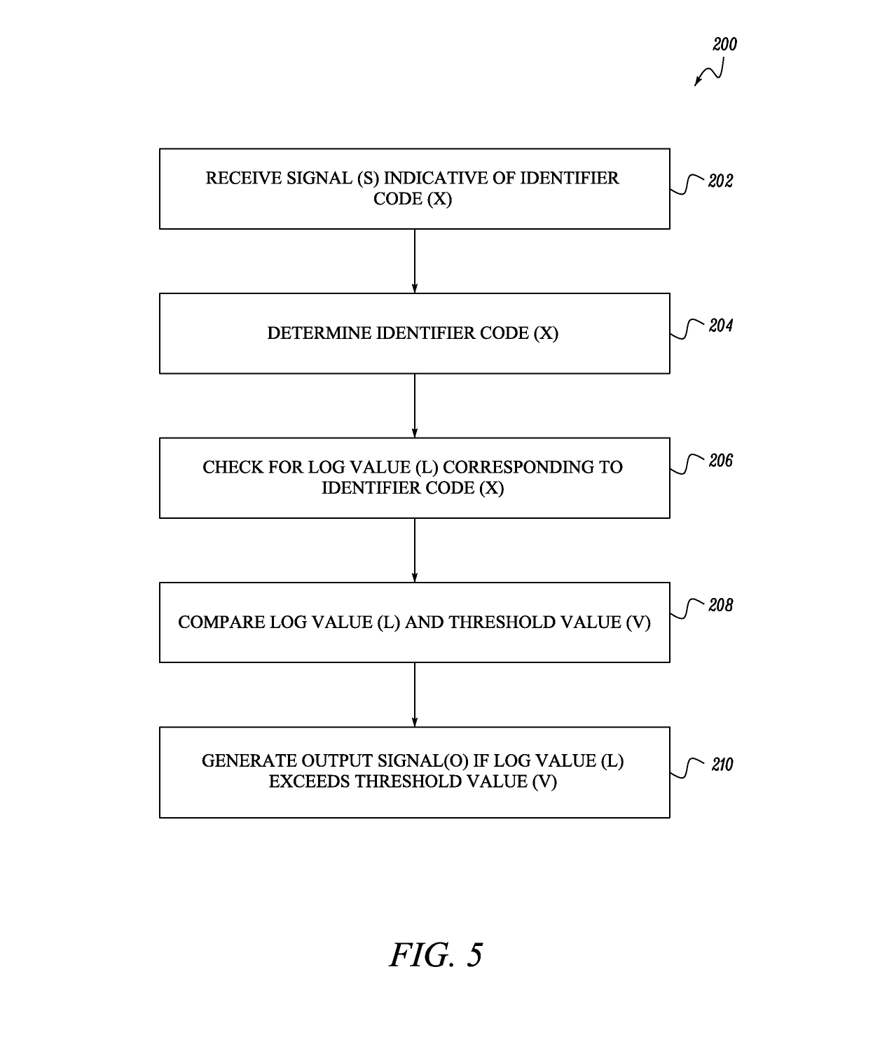

FIG. 5 diagrammatically illustrates a computer implemented method 200 for checking the validity of the service component 110 of the machine 100, according to which the control system 130 may be configured to operate. As shown in step 202, the method 200 includes receiving the signal ‘S’ indicative of the identifier code ‘X’ associated with the service component 110. The signal ‘S’ may be received by the transceiver 132, in the perception unit 131 of the control system 130. Further in step 204, the method 200 includes determining the identifier code ‘X’ from the signal ‘S’. The microcontroller 134 may decode the signal ‘S’ to determine the identifier code ‘X’ using the predefined wireless communication standard. The microcontroller 134 may also decrypt the signal ‘S’ to determine the identifier code ‘X’. Further the identifier code ‘X’, as determined, may be stored in the memory 136 of the perception unit 131.

In step 206, the method 200 includes checking for the log value ‘L’ corresponding to the identifier code ‘X’. This may include matching the identifier code ‘X’ with the set of pre-stored identifier codes, as stored in the memory unit 142 of the database 140. The controller 146, in the control system 130, may issue instructions to the processing unit 144 to compare the identifier code ‘X’, as determined, with the pre-stored identifier codes ‘Y’ in the set of pre-stored identifier codes. The processing unit 144 may check and find the pre-stored identifier code ‘Y’ which matches the identifier code ‘X’. Further in step 208, the method 200 includes comparing the log value ‘L’ and the threshold value ‘V’. The controller 146 may utilize a set of algorithms defined therein for the purpose. In step 210, the method 200 includes generating the output signal ‘O’, indicative of the validity of the service component 110, if the log value ‘L’ exceeds the threshold value ‘V’. The method 200 may also include communicating the output signal ‘O’, as generated, via the output device 148.

While aspects of the present disclosure have been particularly shown and described above, it will be understood by those skilled in the art that various additional aspects may be contemplated by the modification of the disclosed systems and methods without departing from the spirit and scope of what is disclosed. Such aspects should be understood to fall within the scope of the present disclosure as determined based upon the claims and any equivalents thereof.

What is claimed is:

1. A method for checking a validity of a service component of a machine, the method comprising:
receiving a signal indicative of an identifier code associated with the service component;
determining the identifier code based on the signal;
checking for a log value corresponding to the identifier code;
comparing the log value and a threshold value; and
generating an output signal, indicative of the validity of the service component, if the log value exceeds the threshold value.

2. The method of claim 1 further comprising, matching the identifier code with a pre-stored identifier code in a database, the database comprising the log value associated with the pre-stored identifier code.

3. The method of claim 1, wherein the log value comprises an event log, the event log corresponding to number of times one or more service components associated with the identifier code have been installed in one or more machines.

4. The method of claim 1, wherein the log value comprises a time log, the time log corresponding to a length of time one or more service components associated with the identifier code have been operational in one or more machines.

5. The method of claim 1, wherein the signal comprises a Bluetooth Low Energy signal.

6. The method of claim 1, wherein the signal comprises one of a Bluetooth signal, an RFID signal, an infrared signal, a Wi-Fi signal, a NFC signal, a cellular signal, a RuBee signal and a hybrid signal.

7. A control system for checking a validity of a service component of a machine, the control system comprising:
a perception unit configured to receive a signal indicative of an identifier code associated with the service component, the perception unit further configured to determine the identifier code based on the signal; and
a controller configured to:
check for a log value corresponding to the identifier code;
compare the log value and a threshold value; and
generate an output signal, indicative of the validity of the service component, if the log value exceeds the threshold value.

8. The control system of claim 7 further comprising a database having a set of pre-stored identifier codes and log values associated with each of the pre-stored identifier codes, and wherein the controller is configured to match the identifier code with the pre-stored identifier code.

9. The control system of claim 8, wherein the database is located in a cloud based server.

10. The control system of claim 8 further comprising a communication device configured to access the database.

11. The control system of claim 7, wherein the log value comprises an event log, the event log corresponding to number of times one or more service components associated with the identifier code have been installed in one or more machines.

12. The control system of claim 7, wherein the log value comprises a time log, the time log corresponding to a length of time one or more service components associated with the identifier code have been operational in one or more machines.

13. The control system of claim 7, wherein the perception unit is configured to receive the signal comprising a Bluetooth Low Energy signal.

14. The control system of claim 7, wherein the perception unit is configured to receive the signal comprising one of a Bluetooth signal, an RFID signal, an infrared signal, a Wi-Fi signal, a NFC signal, a cellular signal, a RuBee signal and a hybrid signal.

15. A machine comprising:
a frame;
a service component installed in the frame; and
a control system for checking a validity of the service component, the control system comprising:
a perception unit configured to receive a signal indicative of an identifier code associated with the service component, the perception unit further configured to determine the identifier code based on the signal; and
a controller configured to:
check for a log value corresponding to the identifier code;
compare the log value and a threshold value; and
generate an output signal, indicative of the validity of the service component, if the log value exceeds the threshold value.

16. The machine of claim 15, wherein the control system further comprises a database having a set of pre-stored identifier codes and log values associated with each of the pre-stored identifier codes, and wherein the controller is configured to match the identifier code with the pre-stored identifier code.

17. The machine of claim 15, wherein the log value comprises a time log, the time log corresponding to a length of time one or more service components associated with the identifier code have been operational in one or more machines.

18. The machine of claim 15, wherein the log value comprises an event log, the event log corresponding to a number of times one or more service components associated with the identifier code have been installed in one or more machines.

19. The machine of claim 15, wherein the perception unit is configured to receive the signal comprising a Bluetooth Low Energy signal.

20. The machine of claim 15, wherein the perception unit is configured to receive the signal comprising one of a Bluetooth signal, an RFID signal, an infrared signal, a Wi-Fi signal, a NFC signal, a cellular signal, a RuBee signal and a hybrid signal.
